(19) United States
(12) Patent Application Publication
(10) Pub. No.: US 2016/0018895 A1
(43) Pub. Date: Jan. 21, 2016

(54) PRIVATE MESSAGING APPLICATION AND ASSOCIATED METHODS

(71) Applicants: Dennis Sidi, Miami, FL (US); Freddy Sidi, Miami, FL (US)

(72) Inventors: Dennis Sidi, Miami, FL (US); Freddy Sidi, Miami, FL (US)

(21) Appl. No.: 14/695,963

(22) Filed: Apr. 24, 2015

Related U.S. Application Data
(60) Provisional application No. 61/983,825, filed on Apr. 24, 2014.

(51) Int. Cl. G06F 3/01; H04L 29/06; H04L 12/58

(52) U.S. Cl. CPC G06F 3/017; H04L 51/02; H04L 51/16; H04L 51/046; H04L 51/12; H04L 63/04

(57) ABSTRACT

A mobile device application that enables users to easily engage in a private chat that. Users can switch from a normal chat to the private chat by performing a simple gesture. Once the users are finished, they can deactivate the private chat by performing another gesture. Once a user leaves the private chat, all digital data from the chat is permanently deleted and cannot be retrieved.

### CLAIM OF PRIORITY

This application is being filed as a non-provisional patent application under 35 U.S.C. §111(b) and 37 CFR §1.53(c). This application claims priority under 35 U.S.C. §111(e) to U.S. provisional patent application Ser. No. 61/983,825 filed on Apr. 24, 2014, the contents of which are incorporated herein by reference in their entirety.

### FIELD OF INVENTION

The present invention relates to messaging applications for use with personal communication devices or smartphones, and particularly a smartphone or tablet messaging application, and methods associated therewith, for alternating between private and non-private messaging modes based on a number of different interactive actions, or “gestures,” by the application's users.

### BACKGROUND OF THE INVENTION

Smart phone, tablets, and other devices are becoming more and more popular with the general public, especially for messaging other people. Messages are typically transmitted between users through either a data network or through the same wireless cellular network that voice communications are transmitted. Cellular-based transmissions using the short message service (“SMS”) protocol have become the norm. A problem with messaging through either a data network or through the SMS protocol is that there is very little assurance that such communications remain private. Any message sent through the wireless carrier is likely recorded by the carrier, and may be subject to distribution through deliberate and legal means, accidentally, or through illegal “hacking” or misappropriation by unauthorized third parties. Deleting messages from the devices does not necessarily delete the messages, or record associated therewith, from the wireless carrier's server, and allows the message, or its traces, to live on indefinitely.

In an age where everything is increasingly digital, privacy has become harder and harder to maintain. The present invention is intended to help digital conversations remain private and ephemeral, while also making it simple and convenient to switch between a private chat and a normal chat.

### SUMMARY OF THE INVENTION

It is an object of the present invention to provide users with the ability to have quick and easy private conversations. A user can invite other user(s) into a private chat through a gesture. Once invited, the application will notify the other user(s) of the private chat request. The recipient(s) can then choose to accept the invitation by performing a gesture, or recipient(s) can deny or ignore the private chat invitation. If accepted, the users will enter a private chat where they will have increased privacy protection. When either user wishes to end the private chat, the user will perform another gesture and the private chat will terminate. Once the private chat is terminated, all digital data from that chat will be permanently deleted.

### BRIEF DESCRIPTION OF THE DRAWINGS

FIGS. 1A and 1B show two users in a normal conversation.

FIGS. 2A and 2B show the right hand user performing a gesture, in this embodiment turning his or her phone upside-down, to activate private mode and invite the other user to a private chat.

FIGS. 3A and 3B show the left hand user receiving a message inviting him or her to join in a private chat.

FIGS. 4A and 4B show the left hand user accepting the private chat invitation by performing a gesture, in this embodiment turning his or her phone upside-down.

FIGS. 5A and 5B show the users engaged in a private chat.

FIGS. 6A and 6B show the users leaving the private chat and entering a normal chat by performing a gesture, in this embodiment turning their phones right side-up.

### DESCRIPTION OF INVENTION

The preferred embodiment of the present invention consists of a messaging application, and associated methods, installed in a smartphone, tablet, or other device. The application and methods enable users to chat with other user(s), either one-on-one or in groups that also have the application. The application operates in two modes: Normal Mode and Private Mode. In Normal Mode, the users may chat with each other in a manner similar to many other chat services. In Private Mode, messages are displayed and stored on the users' phones only and are never stored in the wireless carrier's servers. To further ensure privacy, the users' print screen function is disabled while in Private Mode preventing them from taking a picture of the private chat. When the users leave Private Mode, the stored information is deleted from the users' phone, and since messages sent while in Private Mode are not stored on a server, no trace of the digital conversation will be preserved anywhere. After a user leaves Private Mode, if he or she reactivates Private Mode, all of the previously sent communications will no longer be available to him or her and there will be no way to access the previous conversation. The new private chat will begin with no record of any prior private communications.

Private messaging operates under a private messaging protocol. Specifically, messages and files are only stored in messaging servers until the recipient receives them, once they have been received the messages are deleted from the messaging servers. Messages are only kept locally while the users are within a private conversation. Once the users leave the conversation, all messages and files are deleted and not retrievable. That way we it can be guaranteed that there are no traces of the messages left by the application.

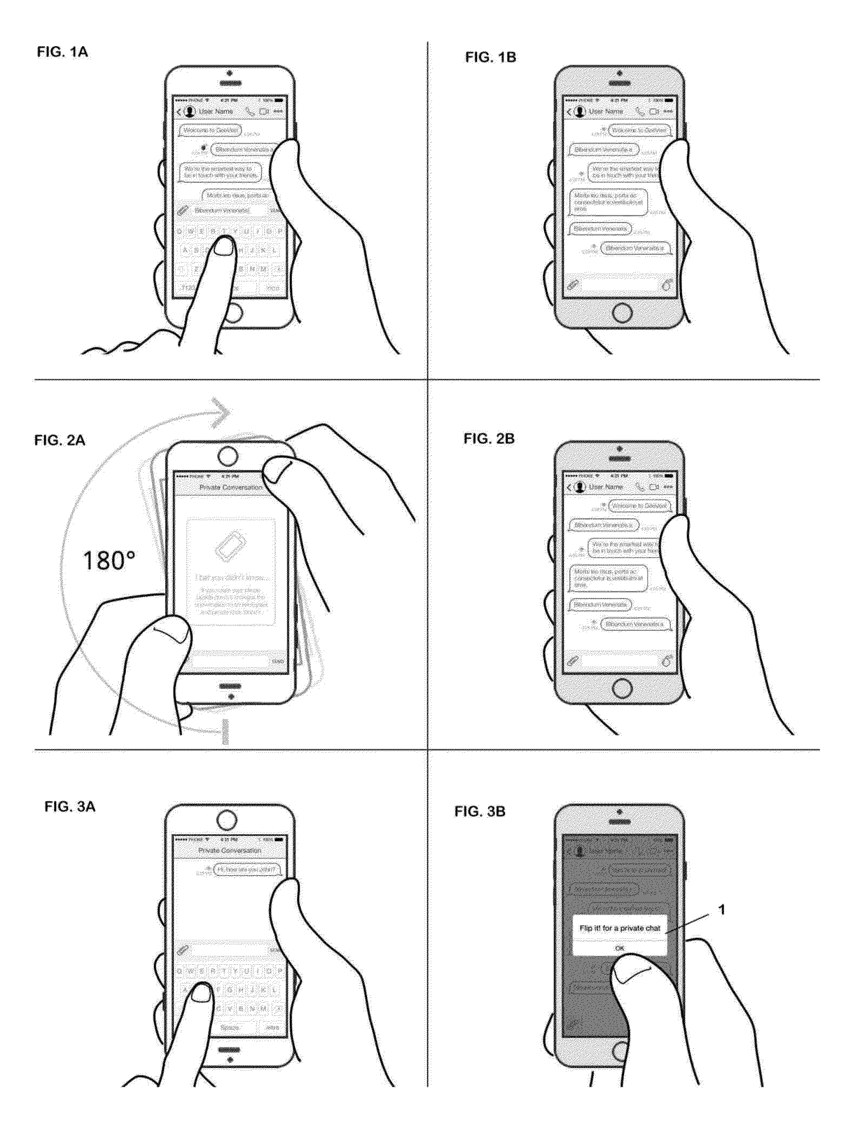

One embodiment of this invention is displayed in the figures. FIGS. 1A and 1B show two users, User A on the left and User B on the right, engaging in a normal chat. In FIG. 2A, User A initiates Private Mode by performing a gesture, in this embodiment turning the phone 180°. The phone recognizes the orientation change through a software-based sensor and derives its data from the accelerometer and geomagnetic field sensor embedded in the device. As shown in FIG. 3B, once User A initiates a private chat, the application will send User B a message 1 that User A wishes to engage in a private chat.

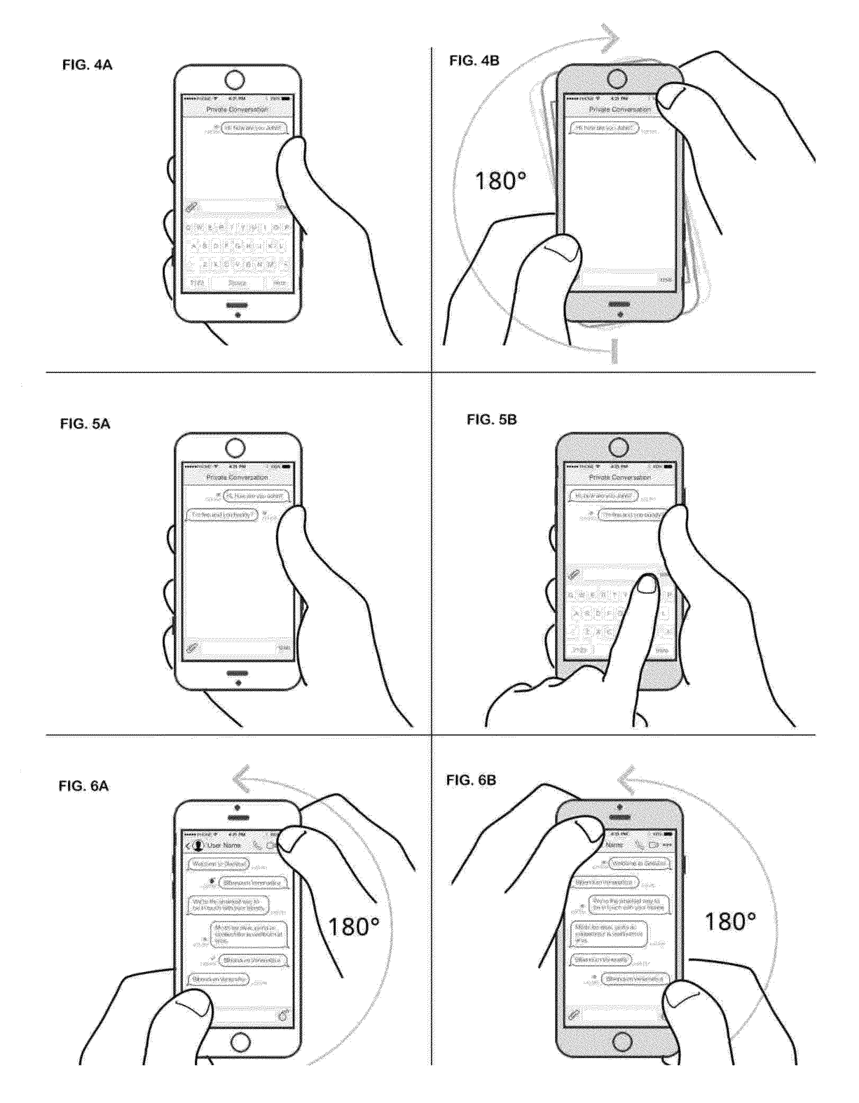

User B can then choose whether to accept the invitation. As shown in FIG. 4B, if User B wishes to join the private chat, he or she will activate Private Mode by performing a gesture, in this embodiment turning the phone upside-down. Once both Users have activated Private Mode they can engage in a private chat, as displayed in FIGS. 5A and 5B. While in Private Mode, the user's info will not be displayed on the screen of the phone.

When they are done with private chatting, the Users can deactivate Private Mode by performing another gesture, in this embodiment turning the phone right side-up, as shown in FIGS. 6A and 6B. If during the private chat a user leaves the application through any means other than deactivation of Private Mode, such as an incoming call, or any other external interaction which may force the application to run in the background, the user will exit Private Mode and all of the data from the private chat will be deleted.

For the application and the servers to differentiate between private chats and normal chats, every message, text or files, within a private conversation is labeled as a “Private.” This allows the application and server to differentiate those messages and eliminate them immediately after the user exits. The message format is as follows: <message id=‘5eDDp-81’ to=‘5555555555@geevee.com’ type=‘chat’ ttl=“0” isPrivate=“true”><body>message</body><x xmlns=“jabber:x:event”></x></message>. Another option is to immediately delete all messages from the application's service provider's server, regardless of whether or not the users are in Private Mode. In this way, there is never a record of the conversation on any server and even in Normal Mode the only record of the conversation is on the users' devices.

There are numerous other embodiments for the present invention. One such embodiment is to utilize different gestures or interactive actions by the user, other than reorienting the phone, to initiate Private Mode. Some examples of these gestures/actions include, but are not limited to, turning the device on its side (“landscape mode”), pressing a physical button on the device, pressing a depiction of a button on the touch-screen of the device, a touch pattern on the touch-screen of the device, shaking the device, other movements of the device, etc. Any of these actions, alone or in combination, may be used to activate or deactivate Private Mode, but are not intended to change any of the other features of Private Mode.

Another embodiment may include a feature that allows for a time limit to accept an invitation to Private Mode. If the recipient of the invitation does not initiate Private Mode within the time limit, the invitation is automatically canceled.

Another embodiment is to have a group chat, whereby multiple users can all enter into one private chat. Similar to the embodiment described above, one user will activate Private Mode by performing a gesture. Then, all of the other users will receive invitations to the private chat. If users decline the invitation to enter Private Mode, they will not be able to read messages sent in Private Mode. Only users who accept the private chat invitation and enter Private Mode will be able to receive or send messages in the private chat. Groups may be as large as desired.

In another embodiment, if a sender sends a private message to a recipient there are multiple ways that the second user will be alerted to the message, based on the situation. If both parties are currently reengaged in a private chat, then the private message will simply appear on the recipient's screen. If the recipient is not in a private chat with the sender, but they the parties are engaged in a normal chat in the application, the application will send a pop-up will alert the recipient that he or she has received a private message. If the recipient is not engaged in a private or normal chat with the sender or is not currently using the application, then the recipient will receive a pending message alert, without any indication that it is a private message. If the recipient enters a normal chat with the sender, the recipient will then be alerted to the private message and invited to enter a private chat.

Accordingly, it will be understood that the preferred embodiment of the present invention has been disclosed by way of example and that other modifications and alterations may occur to those skilled in the art without departing from the scope and spirit of the appended claims.

1. A smart device chat application wherein:
an originating user and a recipient user both have the chat application installed on their personal communication device;
the chat application, when launched, has a normal mode which allows the users to send messages to each other and the chat application maintains a transcript of the messages sent;
upon the originating user launching the chat application and then activating his personal communication device, said chat application switches from normal mode to a privacy mode, wherein the originating user and the recipient user may engage in a private chat;
upon the originating user initiating said privacy mode, the chat application sends an alert to the recipient user that the originating user wishes to engage in said private chat;
upon the recipient user launching the chat application and activating his personal communication device, the recipient user will be joined into said private chat with the originating user;
while in private chat the originating user and the recipient user may send messages to each other.
either the originating user or the recipient user may terminate the private chat by deactivating their personal communication device;
wherein upon termination of the private chat any messages, sent or received, in the private chat are permanently deleted.

2. The smart device chat application of claim 1, wherein activation of one of the personal communication devices is when the personal communication device is turned up-side down and de-activated when the personal communication device is turned right-side up.

3. The smart device chat application of claim 1, wherein activation of one of the personal communication devices is when the personal communication device is turned into a horizontal orientation and de-activated when the personal communication device is turned into a vertical orientation.

4. The smart device chat application of claim 1, wherein activation of one of the personal communication devices is when an activation button on the personal communication device is pressed and de-activated a de-activation button on the personal communication device is pressed.

5. The smart device chat application of claim 1, wherein activation of one of the personal communication devices is when the personal communication device is shaken and de-activated when the personal communication device is shaken again.

6. The smart device chat application of claim 1, wherein giving a time limit for the second user to activate its personal communication device after receipt of the private message session invitation.

7. A method for carrying out a private messaging session comprising the steps of:
from a first personal communication device, transmitting a public messaging session invitation to a second personal communication device;
upon acceptance of said public messaging session invitation, initiating a public messaging session between said first and second personal communication devices;
maintaining a record of any messages exchanged between said first and second communication devices while they are engaged in a public messaging session;
detecting whether one of said first or second personal communication devices is activated;
upon detecting device being activated, transmitting a private messaging session invitation from said activated personal communication device to the other device wherein said private messaging session invitation requests that said other device be activated;
upon detecting that said other device has been activated, initiating a private messaging session between said first and second personal communication devices;
upon detecting that one of said first or second personal communication devices is de-activated, terminating said private messaging session between said first and second personal communication devices; and
upon termination of said private messaging session, permanently deleting all records of any messages exchanged between said first and second communication devices while they were engaged in said private messaging session.

8. The method for carrying out a private messaging session of claim 7, wherein activation of one of the personal communication devices is when the personal communication device is turned up-side down and de-activated when the personal communication device is turned right-side up.

9. The method for carrying out a private messaging: session of claim 7, wherein activation of one of the personal communication devices is when the personal communication device is turned into a horizontal orientation and de-activated when the personal communication device is turned into a vertical orientation.

10. The method for carrying out a private messaging session of claim 7, wherein activation of one of the personal communication devices is when an activation button on the personal communication device is pressed and de-activated a de-activation button on the personal communication device is pressed.

11. The method for carrying out a private messaging session of claim 7, wherein activation of one of the personal communication devices is when the personal communication device is shaken and de-activated when the personal communication device is shaken again.

12. The method for carrying out a private messaging session of claim 7, wherein giving a time limit for the second user to activate its personal communication device after receipt of the private message session invitation.

13. The method for carrying out a private messaging session of claim 7, wherein a print screen function of said personal communication devices is disabled.

14. A method for carrying out a private messaging session comprising the steps of:
from a first personal communication device, transmitting a public messaging session invitation to one or more recipient personal communication devices;
upon acceptance of said public messaging session invitation, initiating a public messaging session between said first and said recipient personal communication devices;
maintaining a record of any messages exchanged between said personal communication devices while they are engaged in a public messaging session;
detecting whether one of said personal communication devices is activated;
upon detecting said personal communication device is activated, transmitting a private messaging session invitation from said activated personal communication device to the said recipient communication devices wherein said private messaging session invitation requests that said other devices be activated;
upon detecting that said other device has been activated, initiating a private messaging session between said first and said recipient personal communication devices;
upon detecting that one of said first or said recipient personal communication devices is de-activated, terminating said private messaging session between said personal communication devices; and
upon termination of said private messaging session, permanently deleting all records of any messages exchanged between said personal communication devices while they were engaged in said private messaging session.

15. The method for carrying out a private messaging session of claim 14, wherein activation of one of the personal communication devices is when the personal communication device is turned up-side down and de-activated when the personal communication device is turned right-side up.

16. The method for carrying out a private messaging session of claim 14, wherein activation of one of the personal communication devices is when the personal communication device is turned into a horizontal orientation and de-activated when the personal communication device is turned, into a vertical orientation.

17. The method for carrying out a private messaging session of claim 14, wherein activation of one of the personal communication devices is when an activation button on the personal communication device is pressed and de-activated a de-activation button on the personal communication device is pressed.

18. The method for carrying out a private messaging session of claim 14, wherein activation of one of the personal communication devices is when the personal communication device is shaken and de-activated when the personal communication device is shaken again.

19. The method for carrying out a private messaging session of claim 14, wherein giving a time limit for said recipient to activate its personal communication device after receipt of the private message session invitation.

20. The method for carrying out a private messaging session of claim 14, wherein a print screen function of said personal communication devices is disabled.
